(19) United States
(12) Patent Application Publication
(10) Pub. No.: US 2010/0312624 A1
(43) Pub. Date: Dec. 9, 2010

(54) ITEM ADVERTISEMENT PROFILE

(75) Inventor: Mikhail Bilenko, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,939

(22) Filed: Jun. 4, 2009

(51) Int. Cl. G06Q 30/00; G06F 17/00

(52) U.S. Cl. 705/14.5; 705/14.54; 705/14.58; 705/14.64; 705/14.66; 705/14.71; 715/246

(57) ABSTRACT

A method disclosed herein includes accessing a data repository that comprises an item advertisement profile for a user, wherein the item advertisement profile for the user comprises data pertaining to items of interest to the user and pricing preferences that correspond to at least one item of interest to the user. The method further includes selecting an item advertisement for a particular item from a plurality of possible item advertisements based at least in part upon the item advertisement profile for the user and causing the advertisement for the particular item to be displayed to the user on a display screen of a computing device.

### BACKGROUND

An incredible amount of information is accessible to individuals who have access to a networked device. Pursuant to an example, a user can search for a particular topic by proffering a search query to a search engine. The search engine, utilizing the proffered query, can locate and rank numerous web pages and provide such pages to the user. Therefore, for instance, a web page deemed most relevant to the user (given the proffered query) will be displayed most prominently to the user, while other less relevant pages will be displayed less prominently.

Along with facilitating location of information, the Internet is being used for generation of revenue. For instance, a retailer can create a website that is designed for the sale of goods and services offered by the retailer. In addition, websites exist that are dedicated to auctioning goods and/or services offered by retailers and/or individuals. Oftentimes, consumers prefer purchasing items online, as they can avoid hassles associated with driving to shopping centers.

Another manner in which the Internet has been used to generate revenue is through sale of advertisements that are displayed on web pages. For instance, when a user proffers a query to a search engine, the query can be made available to prospective advertisers. The advertisers purchase space on a web page that shows search results based at least in part upon the query. For instance, if the user searches for “digital camera”, a retailer that sells digital cameras may wish to provide an advertisement to the user in hopes that the user will purchase a digital camera from the retailer. Revenue can be generated by the search engine, for instance, if the user selects the advertisement. Web pages can also sell space to advertisers to generate revenue for the owner of the web page. Conventionally, online advertising relies on immediate context for selecting relevant advertisements to display to users. Immediate context may include a current search query, queries proffered by a user in a single session, and page content of a web page where an advertisement is displayed.

### SUMMARY

The following is a brief summary of subject matter that is described in greater detail herein. This summary is not intended to be limiting as to the scope of the claims.

Described herein are various technologies related to online advertising in general and providing relevant advertisements to users through use of item advertisement profiles in particular. As described in greater detail herein, an item advertisement profile can be generated for a user with respect to item advertisements such that relevant item advertisements are provided to the user. As used herein, an item advertisement is an advertisement for a particular item or set of items at a specific price that is displayed to the user in the advertisement. Often the specific price will include a relatively significant discount from a typical retail price.

An item advertisement profile for a particular user may include or be associated with data that is indicative of items of interest to the user. For example, a user may be interested in golf, therefore, an item advertisement profile for the user may include data that indicates that the user is interested in the sport of golf as well as certain items that are likely to be of interest to the user such as a certain type of golf clubs, a particular type of golf ball, etc. Furthermore, the item advertisement profile for the user may include data that is indicative of pricing preferences of the user. For instance, pricing preferences as used herein can include a particular percentage discount off of a manufacturer's suggested retail price, a certain percentage off a current market rate, etc. In another example, pricing preferences may include a certain price range within which the user may be interested in purchasing certain items.

Item advertisement profiles for users can be generated based upon implicitly learned interests of users and/or data explicitly provided from users. For example, online behavior of a user can be observed such as search queries issued by the user, browsing patterns of the user, etc., and preferences for certain items or types of items can be inferred. Furthermore, a graphical user interface may be provided to the user that is configured to receive explicit information pertaining to preferences of items from the user. For example, the graphical user interface may allow the user to specify particular brands that are of interest to the user, categories of items that are of interest to the user, pricing preferences, etc. Furthermore, controls may be provided to the user that allow the user to define what data pertaining to the user can be collected. For instance, the user may wish to have search queries monitored to infer preferences of the user but may wish to not have browsing activities monitored. Thus, the user has control over what data pertaining to the user is collected.

In an example operation, an item advertisement profile for a user can be employed to provide an item advertisement to the user based upon some sort of contextual data pertaining to the user. For example, the user may issue a query to a web-based search engine and such query can be used in connection with providing an item advertisement to a user. For example, if the user enters a search for “golf clubs” the item advertisement profile can be accessed and a brand and price range of golf clubs that are believed to be of interest to the user can be ascertained and employed in connection with providing a relevant item advertisement to the user.

Other aspects will be appreciated upon reading and understanding the attached figures and description.

### BRIEF DESCRIPTION OF THE DRAWINGS

FIG. 1 is a functional block diagram of an example system that facilitates providing a relevant item advertisement to a user.

FIG. 2 is a functional block diagram of an example system that facilitates building an item advertisement profile for a user.

FIG. 3 is a functional block diagram of an example system that facilitates updating an item advertisement profile based upon contextual data pertaining to a user.

FIG. 4 is a functional block diagram of an example system that facilitates monitoring quality of advertisement provided to a user.

FIG. 5 is an example graphical user interface that provides a user with a control pertaining to what type of data is monitored in connection with building an item advertisement profile.

FIG. 6 is an example graphical user interface that provides a utility for a user to explicitly indicate key words, brands, categories, etc. of interest to the user.

FIG. 7 is an example graphical user interface that depicts where on a web page an item advertisement can be displayed.

FIG. 8 is flow diagram that illustrates an example methodology for using an item advertisement profile to select an advertisement for display to a user.

FIG. 9 is a flow diagram that illustrates an example methodology for providing an advertisement to a user.

FIG. 10 is a flow diagram that illustrates an example methodology for building an item advertisement profile for a user.

FIG. 11 is an example computing system.

### DETAILED DESCRIPTION

Various technologies pertaining to item advertisements will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

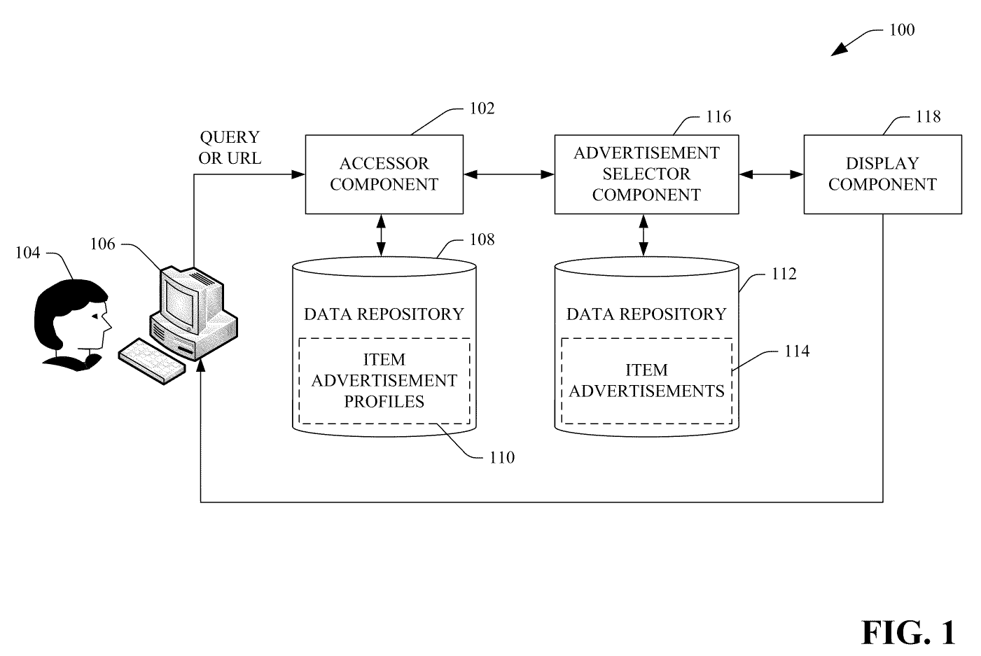

With reference to FIG. 1, an example system 100 that facilitates providing an item advertisement to a user is illustrated. As used herein, an item advertisement can refer to an advertisement for a particular item or set of items that is to be displayed on a web page by way of a web browser, wherein the advertisement for the particular item or set of items is for a certain displayed price or prices. Pursuant to an example, at least a portion of the system 100 may be included in a server that is accessible by way of a network (e.g., the Internet). For instance at least a portion of the system 100 may be included in a search engine and/or an advertisement server.

The system 100 includes an accessor component 102 that receives one or more of a query to a search engine from a user 104 or an identity of a web page being viewed or desirably viewed by the user 104. For example, the user 104 may be utilizing a computing device 106 that has a web browser installed and executing thereon. The user 104 may cause the web browser to be directed toward a web page corresponding to a search engine and may enter a search query into a search field. Such query can be transmitted by way of any suitable network and can be received by the accessor component 102. In another example, the user 104 may enter a Uniform Resource Locator (URL) into a URL field of the web browser, thereby causing the web browser to display a web page to the user that corresponds to the entered URL. While the accessor component 102 is shown as receiving the query or URL, it is to be understood that the accessor component 102 may be configured to receive other data that pertains to the context of the user 104. For instance, the user 104 may be utilizing a mobile telephone that includes location determining functionality such as GPS/triangulation. The accessor component 102 can receive the determined location of the user 104.

The system 100 further includes a data repository 108 that comprises a plurality of item advertisement profiles 110. An item advertisement profile in the item advertisement profiles 110 for a particular user can include data that is indicative of one or more items of interest to the user and pricing preferences for items of interest to the user. Pursuant to an example, an item advertisement profile for a user may include data indicative of a particular brand or brands that are of interest to a user, keywords, categories or types of items (e.g., outdoor items, camping items, golf items), identities of very specific items of interest to the user, etc. Furthermore, the item advertisement profile may comprise data indicative of a discount off of a suggested retail price that is of interest to the user (e.g., the user only wishes to receive advertisements where the discount is at least 30 percent off of the suggested retail price), a certain price range that is of interest to the user (e.g., less than $50), and/or other pricing preferences.

Responsive to receipt of the query, URL and/or other contextual data pertaining to the user 104, the accessor component 102 can access the data repository 108 and can locate the item advertisement profile pertaining to the user 104. Construction of an example item advertisement profile for a user is described in greater detail below.

The system 100 further includes a second data repository 112 that comprises a plurality of item advertisements 114 pertaining to multiple items of various manufacturers/retailers. An advertisement selector component 116 can be in communication with the accessor component 102 and may select an item advertisement from amongst the plurality of item advertisements 114 in the data repository 112 based at least in part upon the item advertisement profile for the user 104. Furthermore, the advertisement selector component 116 can select the advertisement based at least in part upon the query, URL, or other contextual data pertaining to the user 104. Pursuant to an example, the advertisement selector component 116 may act in a restricted manner such that the advertisement selector component 116 cannot select an item advertisement that is in conflict with the item advertisement profile accessed by the accessor component 102. Thus, if the item advertisement profile indicates that the user does not wish to purchase items over a particular price (e.g., $100), the advertisement selector component 116 will refrain from selecting an item advertisement that has a price above the threshold price indicated in the item advertisement profile. Pursuant to an example, explicit instructions can be received from the user pertaining to the pricing preferences of the user 104, and the explicit instructions can be included in the item advertisement profile for the user 104. The advertisement selector component 116 may then fail to select a certain one of the plurality of possible item advertisements due to violation of the received explicit instructions. Moreover, the advertisement selector component 116 may select multiple advertisements included in the data repository 112, if such advertisements are deemed to be relevant as determined through analysis of the item advertisement profile for the user 104.

The system 100 may also include a display component 118 that causes the at least one advertisement selected by the advertisement selector component 116 to be displayed to the user 104 on the display screen of the computing device 106. For instance, the display component 118 may cause the advertisement to be embedded in a web page presented to the user 104 on the display screen of the computing device 106. In another example, the computing device 106 may be a mobile device with relatively limited display area, and the display component 118 can configure the advertisement selected by the advertisement selector component 116 to be displayed to the user 104 on the display screen of the (mobile) computing device 106.

In an example non-limiting operation of the system 100, the user 104 may utilize a web browser executing on the computing device 106 to access a search engine. The user 104 may then provide a query to the search engine which is configured to execute a search based at least in part upon the received query. The accessor component 102 can receive the query and can additionally receive data that is indicative of identity of the user 104. For instance, the user 104 may be signed in to a particular service. In another example, an IP address corresponding to the computing device 106 may be used in connection with identifying the user.

Responsive to receiving data that identifies the user 104, and responsive to receiving the query, the accessor component 102 can access the data repository 108 to locate the item advertisement profile that corresponds to the user 104. The accessor component 102 may then provide the advertisement selector component 116 with the item advertisement profile that corresponds to the user 104 or alternatively may provide the advertisement selector component 116 with a location in the data repository 108 corresponding to the item advertisement profile of the user 104.

The advertiser selector component 116 can select an item advertisement from the plurality of item advertisements 114 in the data repository 112 based at least in part upon the query proffered by the user 104 and the item advertisement profile of the user 104. For example, the user 104 may have issued a query of “blue jeans.” The item advertisement profile for the user may indicate that the user is interested in a particular brand of jean so long as the price is below $70. Moreover, the item advertisement profile of the user 104 may indicate that the user 104 wishes to receive advertisements that are highly relevant to queries issued by the user 104. Thus, for instance, if the user 104 issued a query for power tools, the advertisement selector component 116 will refrain from selecting an advertisement for blue jeans for such query.

The display component 118 may then cause the advertisements for the blue jeans (at or below the defined price) to be displayed to the user 104 on the display screen of the computing device 106. For instance, the display component 118 can cause the advertisement to be displayed relatively prominently with respect to search results located during execution of the query. The user 104 may then purchase or make progress toward purchasing the item in the item advertisement displayed to the user 104 by the display component 118. For instance, the advertisement may be in the form of a selectable hyperlink, wherein selection of such hyperlink causes the web browser to be directed to a web page that facilitates purchasing the advertised blue jeans.

Advertisements displayed to the user 104 on the display screen of the computing device 106 can be monetized in any suitable manner. For instance, the advertiser may provide payment to a search engine or web page based upon whether or not the user 104 clicks on the item advertisement. In another example, the advertiser can provide payment based on whether or not the advertisement was displayed to the user (e.g., pay per impression). Other manners of monetizing the advertisement are also contemplated and intended to fall under the scope of the hereto appended claims.

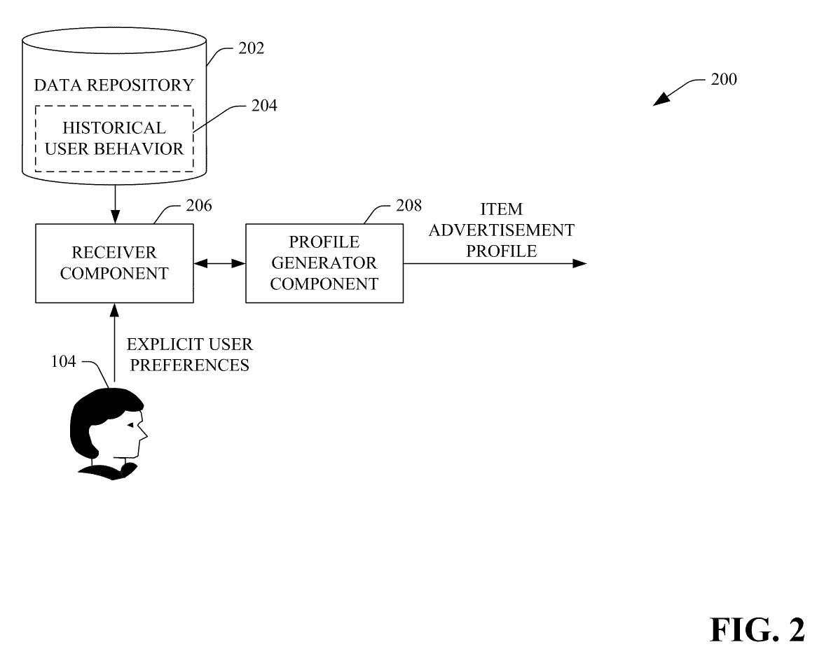

Referring now to FIG. 2, an example system 200 that facilitates building an item advertisement profile is illustrated. The system 200 includes a data repository 202 that comprises historical user behavior 204. The historical user behavior 204 may include online historical activities of the user 104. For instance, the historical user behavior 204 may include information that can be found in search logs pertaining to the user including but not limited to queries issued by the user 104, web pages displayed to the user 104 upon executing a user query, web pages visited upon the user 104 being displayed search results, etc. The historical user behavior 204 may also include information indicative of purchase histories of the user 104. For example, items purchased and amount paid for such items may be included in the historical user behavior 204. Still further, user interaction with online advertisements may be included in the historical user behavior 204. In yet another example, offline activities of the user may be included in the historical user behavior 204. Offline activities may be or include previous trips taken by the user 104, locations where the user has traveled over a window or windows of time, etc.

The historical user behavior 204 in the data repository 202 may only be recorded and maintained with informed consent of the user 104. For example, a graphical user interface can be provided to the user 104 that informs the user of what data can be collected and the user 104 can specify which data is acceptable for collection and retention, how long data can be retained, what types of data can be collected and retained, etc. For instance, the user 104 may wish to have search queries monitored and retained for the purposes of generating an item advertisement user profile but may not wish to have browsing activities retained. Still further, the user 104 may specify different times of day where they wish to have data collected. For instance, while the user 104 is at work, the user 104 may not wish to have online activities of the user 104 monitored and retained but outside of working hours the user 104 may wish to have online activities monitored and retained for the purposes of generating an item advertisement profile.

The system 200 may also include a receiver component 206 that is in communication with the data repository 202 and can access the data repository 202 to receive the historical user behavior 204 (e.g., that corresponds to the user 104). In addition, the receiver component 206 can receive explicit item preferences from the user 104. Such explicit user preferences can be captured and retained through utilization of a graphical user interface presented to the user for receipt of explicit user preferences. Explicit preferences that can be provided by the user 104 in connection with items may be or include keywords, brand names of items of interest to the user, categories of items of interest to the user (e.g., golf, camping, etc.), price preferences of the user including but not limited to a discount level of interest to the user, a price range of interest to the user 104, etc. Still further, the user 104 may for particular items indicate a level of relevancy to a web page or query with respect to a certain item advertisement. Thus, the user 104 can indicate that regardless of the relevancy of the query to the item, if price of a particular item goes below a threshold then the user 104 wishes to be provided with an advertisement for that item at the discount price. In another example, the user 104 may indicate that she only wishes to be provided with advertisements for items that are highly related/relevant to a query proffered by the user 104 or a web page being visited by the user 104. For example, the user 104 can indicate that the user 104 only wishes to receive advertisements for blue jeans when the user 104 is viewing a web page pertaining to clothing. These are but a few of the examples of explicit preferences that can be provided by the user 104 with respect to one or more items and other examples or manners of providing explicit user preferences are contemplated and intended to fall under the scope of the hereto appended claims.

A profile generator component 208 can be in communication with the receiver component 206 and can generate an item advertisement profile for the user 104 based at least in part upon the historical user behavior 204 and the explicit user preferences provided by the user 104. For example, the profile generator component 208 can use any suitable machine learning/data mining technique in connection with inferring/learning preferences of the user 104 pertaining to certain items and/or pricing preferences related to such items based at least in part upon the historical user behavior 204. For example, based upon historical online activity of the user 104 the profile generator component 208 can infer that the user 104 is interested in a particular type or line of clothing. The profile generator component 208 may then augment such inferences and/or restrain such inferences based at least in part upon the explicit preferences provided by the user 104. For instance, the explicit user preferences may include a restriction that any clothing item should be at least 50 percent off the suggested retail price prior to the user 104 considering such item for purchase. Thus, the inference generated by the profile generator component 208 that the user 104 is interested in a particular type of clothing can be constrained by the restriction on pricing explicitly provided by the user 104.

As indicated above, the profile generator component 208 may include or be based at least in part upon any suitable machine learning/data mining technique. These techniques can include, but are not limited to, Bayesian belief networks, artificial neural networks, support vector machines, a k-nearest neighbor classifier, or any other suitable classifier or prediction algorithm.

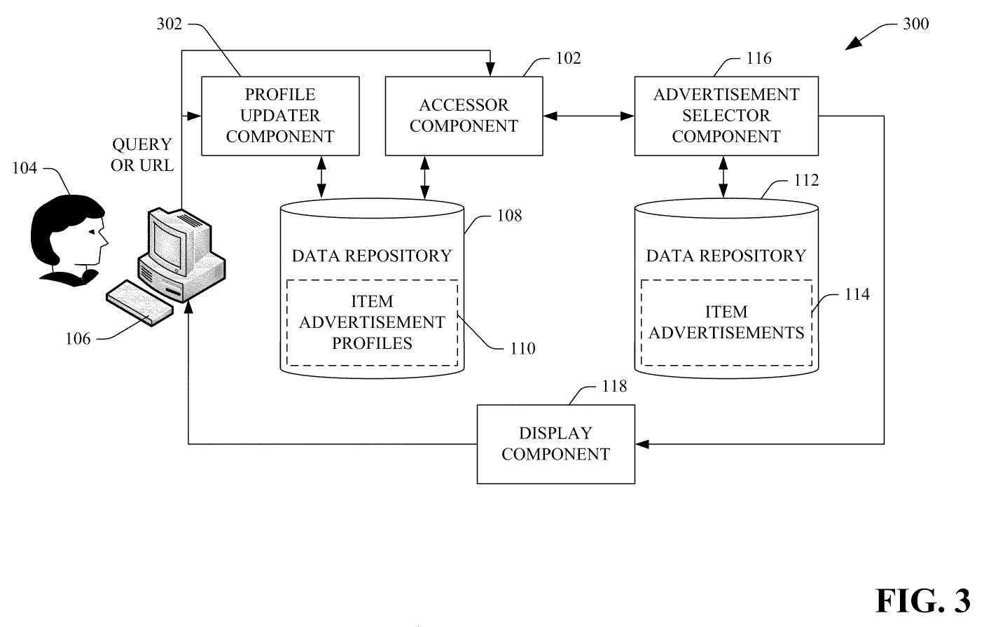

Referring now to FIG. 3, an example system 300 that facilitates automatically updating an item advertisement profile for a user is illustrated. The system 300 includes the accessor component 102 that accesses the item advertisement profiles 110 in the data repository 108 responsive to receipt of a query, URL, or other contextual data from the computing device 106 utilized by the user 104. The advertisement selector component 116 selects at least one advertisement from the plurality of item advertisements 114 in the data repository 112 based at least in part upon the query, URL, or other contextual data and the item advertisement profile of the user 104. The display component 118 causes the at least one selected advertisement to be displayed on the display screen of the computing device 106.

The system 300 further includes a profile updater component 302 that receives the query, URL, or other contextual data from a user 104 and automatically updates the item advertisement profile of the user 104. For example, a query issued by the user 104 may be indicative of a new interest/item of interest of the user 104. Thus, for instance, if the user 104 searches for a particular brand of golf club, it can be inferred that the user 104 is interested in such brand of golf club even if the user 104 has never before performed such a search. The profile updater component 302 can receive such search queries and can cause the item advertisement profile pertaining to the user 104 to be automatically updated. Thus, the system 300 can be configured to provide the user 104 with relevant item advertisements even as interests of the user 104 change over time.

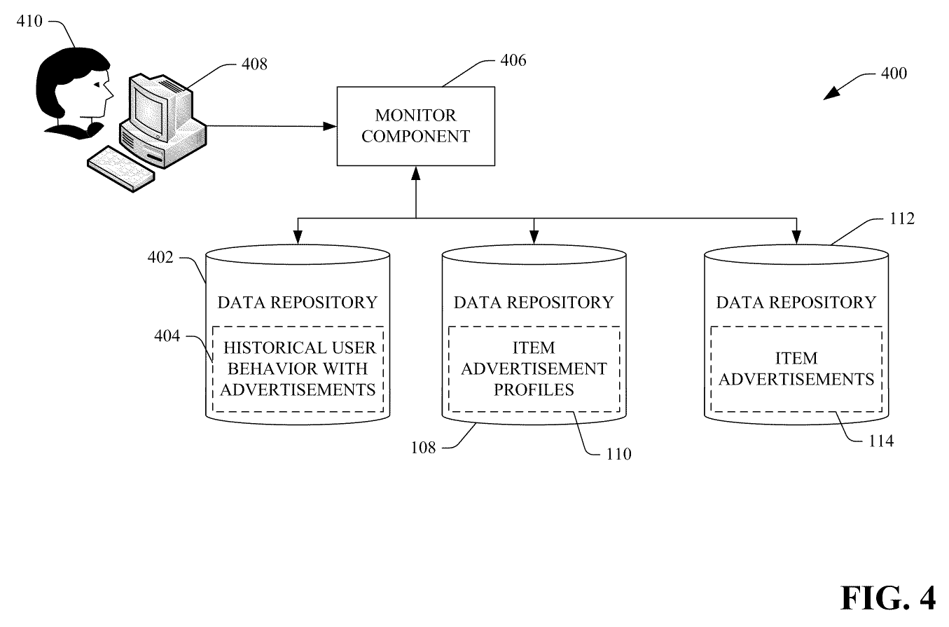

With reference now to FIG. 4, an example system 400 that facilitates monitoring interaction of users with item advertisements is illustrated. The system 400 includes a first data repository 402 that comprises data pertaining to historical user behavior with advertisements 404. For instance, the historical user behavior with advertisements 404 may include data pertaining to which users clicked on which advertisements, which advertisements have clicks relatively infrequently, etc. The system 400 also includes the data repository 108 that comprises the item advertisement profiles 110 for different users. Additionally, the system 400 comprises the data repository 112 that includes the plurality of item advertisements 114 that may be displayed to users.

A monitor component 406 can have access to the data repository 402, the data repository 108, and the data repository 112 and thus may have access to the historical user behavior with advertisements 404, the item advertisement profiles 110, and the item advertisements 114. Furthermore, the monitor component 406 can be in communication with at least one computing device 408 utilized by a user 410, wherein the user 410 may be viewing a web page with an advertisement provided thereon or may have selected an advertisement. The monitor component 406 can be configured to undertake quality control actions with respect to advertisements provided to users through utilization of the system 100 (FIG. 1). For instance, the monitor component 406 can ascertain that at least one advertisement in the item advertisement 114 is never clicked on or rarely clicked on by users. Thus, the monitor component 406 can label such advertisement as being one that is generally not of interest to users.

Furthermore, the monitor component 406 can ascertain through analyzing the historical user behavior with advertisements 404 that a particular user frequently clicks on a certain advertisement, thus indicating that the user may be attempting to undertake click fraud with respect to a certain advertiser. Additionally, the monitor component 406 can analyze contents of the data repositories 402, 108 and 112 to locate fraudulent activities undertaken with respect to advertisements. In an example, the monitor component 406 can analyze the item advertisement profiles 110 together with the historical user behavior with advertisements 404 and determine that a certain user is probable to be a robot that automatically clicks on advertisements to drive up costs to a certain advertiser.

In still yet another example, the monitor component 406 can receive explicit feedback from the user 410 by way of the computing device 408 that indicates quality or lack thereof with respect to one or more advertisements in the item advertisements 114. For example, the user 410 may indicate that an advertisement is fraudulent. The monitor component 406 may then label such advertisement as possibly being fraudulent and can perform additional inspection of the advertisement. In another example, the user 410 may indicate through the computing device 408 that a certain advertisement is a great deal. The monitor component 406 may cause the advertisement to be associated with a quality score that is relatively high compared to other quality scores, thereby increasing the likelihood that such advertisement will be presented to users with interests similar to those of the user 410. Other mechanisms for maintaining quality of advertisements with respect to users are also contemplated.

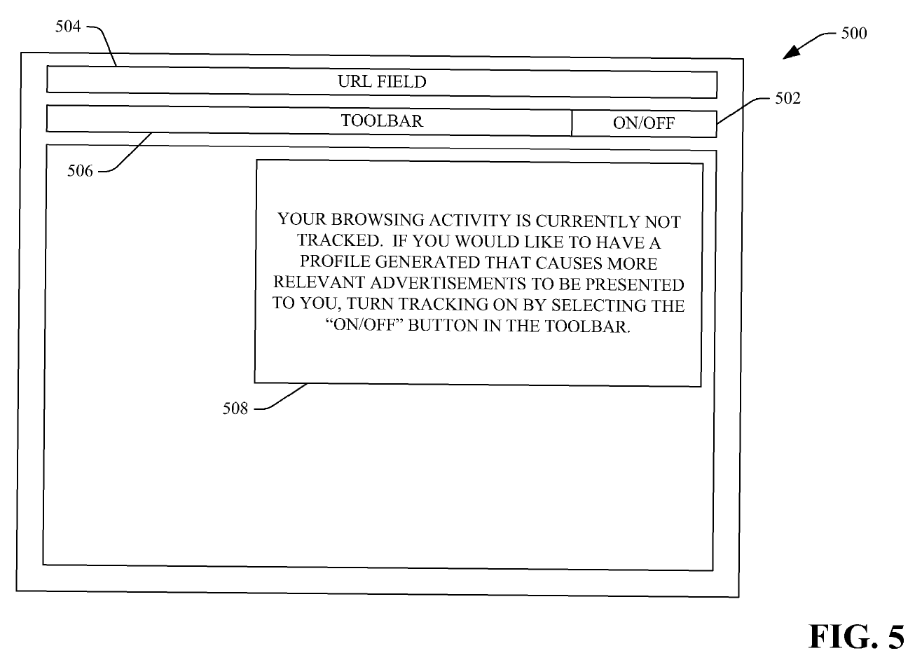

Referring now to FIG. 5, an example graphical user interface 500 is illustrated. The graphical user interface 500 may be or include a depiction of a web browser 502. A user can cause the web browser to display a certain web page by typing a particular address into a URL field 504. The web browser 502 may additionally have a toolbar 506 installed thereon. The toolbar 506 may be installed as an add-on with respect to generating advertisement profiles or may be preinstalled such that the toolbar 506 appears each time the web browser is initiated on a computing device (e.g., the toolbar 506 need not be downloaded at a separate step).

An information field 508 is shown in the web browser, wherein the information field 508 informs a user that online activity of the user is currently not being tracked. Furthermore, the information field 508 includes instructions that inform a user of how to allow online activity of the user to be tracked and used in connection with providing the user with relevant advertisements. For instance, the information field 508 may inform the user of the existence of an ON/OFF button 510 in the toolbar 506 of the web browser 502. The default setting may be to OFF such that online activity of the user is by default not tracked/retained. If the user takes explicit action allowing at least some online activity of the user to be tracked/retained, then, for instance, searches/search history of the user in a web browser and/or browsing activity/history of the user may be tracked and used in connection with generating an item advertisement profile for the user and thus providing the user with relevant advertisements (e.g., advertisements for items relevant to the user's interests).

The example depicted in FIG. 5 is general in nature. It is to be understood that the data collection options may be provided to the user in a granular form. Thus, for example, the user can explicitly state that they wish search queries to be tracked and monitored while they do not wish for browsing activities to be monitored. The user may also provide time restrictions for monitoring data, an amount of data that can be monitored, etc.

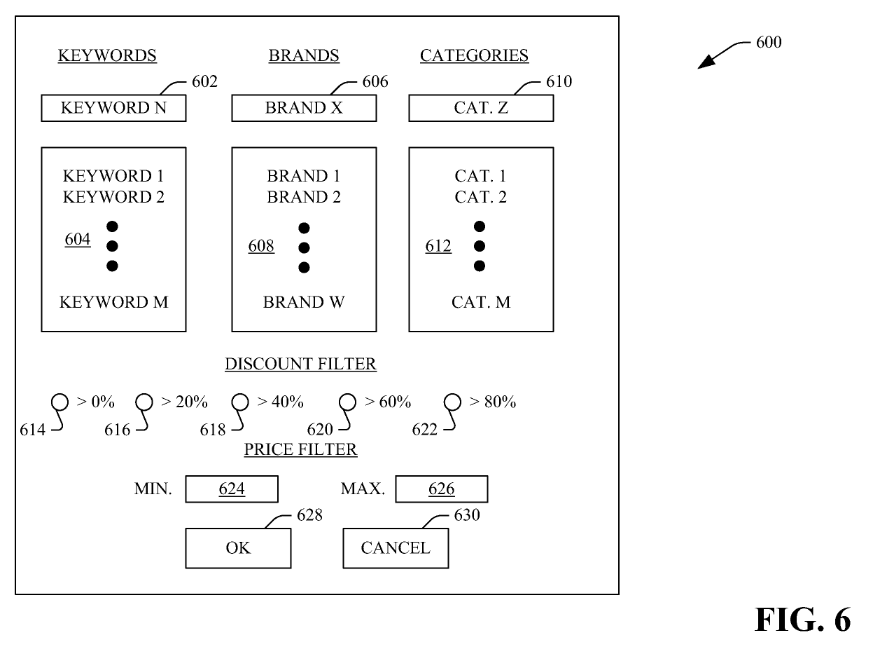

Referring now to FIG. 6, an example graphical user interface 600 that can be used in connection with creating an item advertisement profile for a user is illustrated. The graphical user interface 600 provides a mechanism for the user to provide explicit information pertaining to items of interest to the user and pricing preferences of the user. For example, the graphical user interface 600 may include a first field 602, wherein a user can enter a key word in the first field 602 that pertains to items of interest to the user. For example, a key word can be descriptive of an item, a group of items, etc. A field 604 displays to the user keywords previously entered by such user. The user may then select a keyword from the field 604 and delete or modify such key words as interest of the user changes over time.

The graphical user interface 600 may include a brand field 606 where a user can input a brand name that is of interest to the user. The brand, for example, may be a company, a particular product made by a company, etc. A field 608 can display to the user brands previously input by the user, wherein the user can select a brand in the field 608 and delete/modify the selected brand.

The graphical user interface 600 can also include a category field 610, wherein a user can enter a category that is of interest to the user. Examples of categories may be clothing, camping, hiking, travel, sports, etc. Pursuant to an example, categories can be predefined and selected by the user through utilization of a pull-down menu. In another example, the user may use a cursor and keyboard to generate categories that are to be included/taken into consideration when generating item advertisement profiles. A field 612 can display to the user which categories have previously been entered by the user. Again, the user may delete or modify categories displayed in the field 612.

The graphical user interface 600 also includes a plurality of radio buttons 614-622. Each of the radio buttons corresponds to a particular discount level off of a certain price (e.g., suggested retailer's price, market price, etc.). If the user does not select one of the radio buttons 614-622, the user indicates that she has no preference with respect to discounts of items. If the user selects the radio button 614, the user is indicating that an advertised item must be on sale (e.g., at least less than a retailer's suggested price). If the user selects the radio button 616, the user is indicating that an advertised item must be at least 20 percent off some standard price (e.g., suggested retailer's price). Thus, through use of the graphical user interface 600, the user can indicate how much an item must be on sale to be of interest to the user.

The graphical user interface 600 also includes a field 624 and a field 626 where a user can enter further information pertaining to pricing preferences of items. For instance, the field 624 might correspond to a minimum price (e.g., the user does not wish to see advertisements for items below a certain price). The field 626 may correspond to a maximum price, such that a user can enter a maximum price the user is willing to pay for certain items, brands, etc. The radio buttons 614-622 and the fields 624 and 626 may be general in nature such that they correspond to every possible item being advertised, or such information can correspond to a particular item or category of items. For instance, a user can specify that they do not wish to see advertisements for jeans that cost above $50 but may further indicate that they do not wish to see advertisements for automobiles that are above $30,000.

The graphical user interface 600 additionally includes a button 628, wherein depression of the button 628 causes data entered into the graphical user interface 600 to be transmitted by way of a network to a server, wherein the profile generator component 208 (FIG. 2) can access such information and utilize the information in connection with generating an item advertisement profile for the user. A button 630 is also included in the graphical user interface 600, wherein depression of the button 630 cancels all entries into the graphical user interface 600.

It is to be understood that the graphical user interface 600 is but one example manner and setup for receiving user preferences with respect to items and pricing preferences pertaining to those items. There are, of course, an unlimited number of mechanisms for receiving information pertaining to user interest with respect to items and pricing.

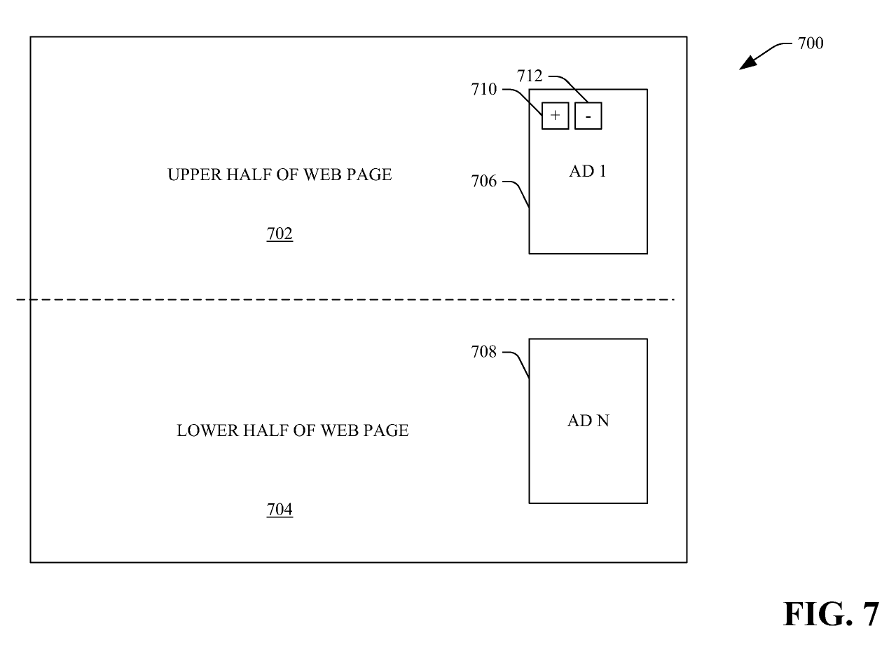

With reference now to FIG. 7, an example web page 700 that includes advertisements displayed thereon is illustrated. As shown, the web page 700 may be conceptually divided into an upper half of the web page 702 and a lower half of the web page 704. Advertisements displayed on the upper half of the web page 702 may be more likely to be noticed by a user than those displayed on the lower half of the web page 704. Thus, the upper half of the web page 702 may include an advertisement 706 that is selected through utilization of an item advertisement profile for a user. The lower half of the web page 704 may include another advertisement 708 that may be selected through other mechanisms, such as conventional key word auction mechanisms.

The advertisement 706 may be likely to be highly relevant to the user as such advertisement 706 is for an item that conforms to the item advertisement profile for the user. Since the advertisement 706 is likely to be highly relevant to the user, such advertisement 706 can be displayed on the upper half of the web page 702. That is, the display component 118 (FIG. 1) can cause the advertisement 706 to be displayed on the upper half of the web page 702. The advertisement 708 may be general (e.g., not directed to a particular item) and may be selected through utilization of conventional key word auction techniques. Since the advertisement 708 is not believed to be as relevant to the user as the advertisement 706, the advertisement 708 can be displayed in a less prominent position on the web page 700 (e.g., on the lower half of the web page 704).

The advertisement 706 may also include selectable icons 710 and 712. The selectable icons 710 and 712 provide a mechanism that allows the user to provide feedback with respect to the advertisement 706. For instance, even if the user does not purchase an item pertaining to the advertisement, the user may find the advertisement 706 to be highly relevant. Accordingly, the user can select the selectable icon 710 which causes an indication that the advertisement 706 is relevant to be transmitted, for instance, to the profile generator component 208 and/or the profile updater component 302. Similarly, if the user does not find the advertisement 706 to be helpful, desired or relevant, the user can select the selectable icon 712, thereby causing an indication to be transmitted to the profile generator component 208 and/or the profile updater component 302, wherein such transmission indicates that the user does not find the advertisement 706 to be relevant. This sort of immediate feedback with respect to a particular item advertisement may be used to further refine an item advertisement profile for the user or to update the quality score for the item advertisement.

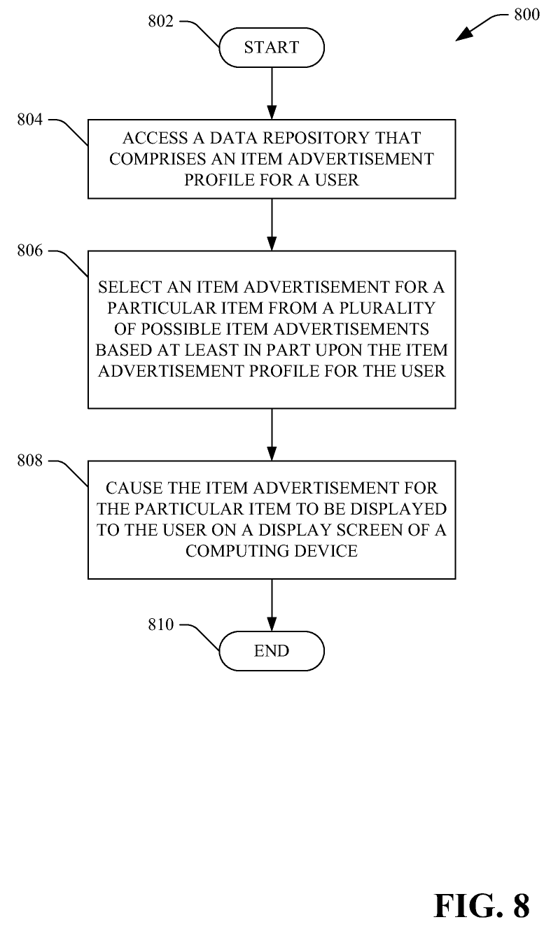

With reference now to FIGS. 8-10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 8, a methodology 800 that facilitates provision of an item advertisement to a user is illustrated. The methodology 800 begins at 802, and at 804 a data repository that comprises an item advertisement profile for a user is accessed. The item advertisement profile for the user can include data pertaining to items of interest to the user and pricing preferences that correspond to at least one item of interest to the user. For example, the pricing preferences may include a price range for the user, a percentage off a manufacturer's suggested retail price, or the like. Furthermore, the item advertisement profile for the user may be based at least in part upon advertisement preferences explicitly provided by the user such as items of interest to the user, key words, categories of interest to the user, etc. Furthermore the contents of the item advertisement profile of the user may be at least partially inferred based at least in part upon monitored online user behavior, such as historic browsing and searching activities of the user.

At 806, an item advertisement is selected for a particular item from a plurality of possible item advertisements based at least in part upon the item advertisement profile for the user. The item advertisement may also be selected based at least in part upon a query received from a user, content on a web page being viewed or desirably viewed by the user, current context of the user including but not limited to location of the user, time of day, day of week, time of a year, events at a location proximate to the user, current weather conditions, a computer device being utilized by the user, predicted weather conditions, a current news item, etc.

At 808, the item advertisement is caused to be displayed to the user on a display screen of the computing device. For instance, the item advertisement for the particular item can be configured for display on a mobile computing device such as a portable telephone. Furthermore, causing the item advertisement for the particular item to be displayed to the user on a display screen of a computing device can include determining an amount of advertising space on a web page that is to be displayed to the user on the computing device and causing the item advertisement for the item to be displayed on an upper half of the web page. Thus, the item advertisement for the item will be displayed prominently to the user. The methodology 800 completes at 810.

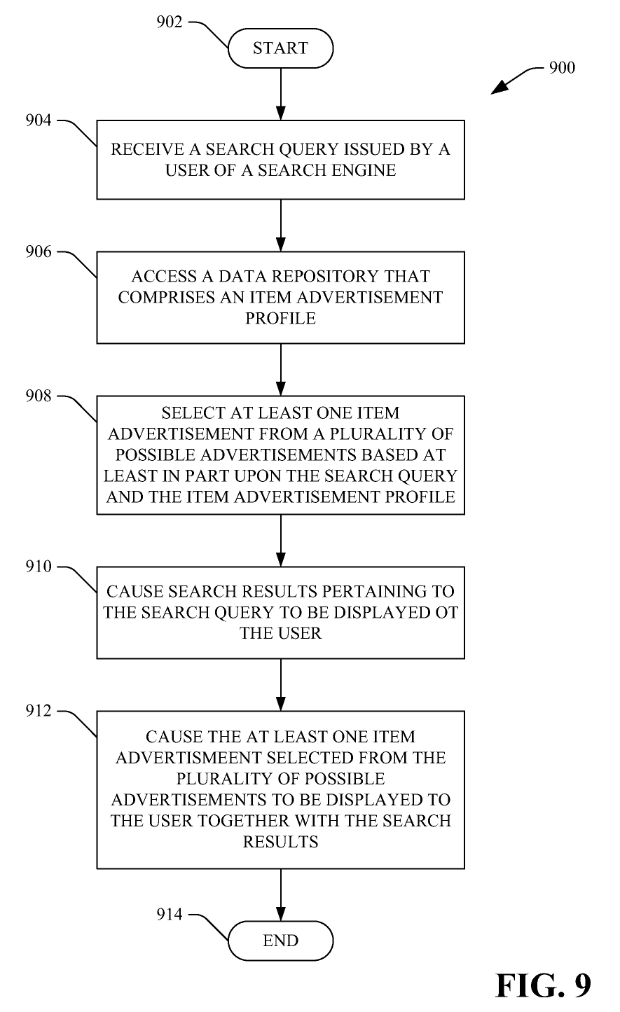

Now referring to FIG. 9, an example methodology 900 for displaying an item advertisement to a user is illustrated in the context of delivering advertisements with respect to a search engine. The methodology 900 starts at 902, and at 904 a search query issued by a user of a search engine is received. At 906, a data repository that includes an item advertisement user profile is accessed. The item advertisement user profile may include data that is indicative of item preferences of the user and price discount preferences of the user with respect to one or more items of interest to the user. Item preferences of the user may include key words describing items of interest to the user, brand names of items of interest to the user, categories of items of interest to the user, etc.

At 908, at least one item advertisement is selected from a plurality of possible advertisements based at least in part upon the search query received at 904 and the item advertisement profile. At 910, search results pertaining to the search query received at 904 are caused to be displayed to the user on a web page and at 912 the at least one item advertisement selected at 908 is caused to be displayed to the user together with the search results. The methodology 900 completes at 914.

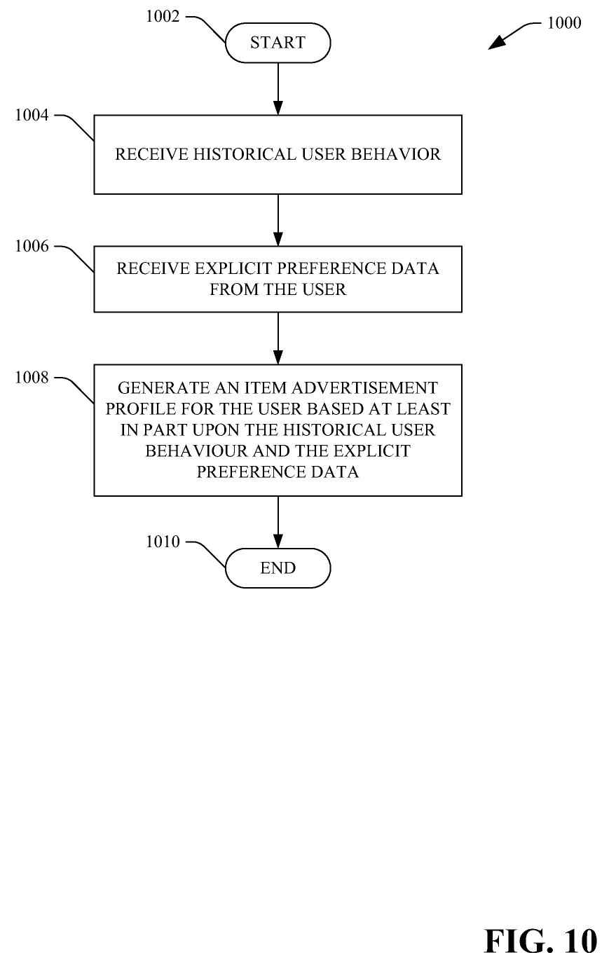

Now referring to FIG. 10, an example methodology 1000 for generating an item advertisement user profile is illustrated. The methodology 1000 starts at 1002 and at 1004 historical user behavior is received. As noted above, the historical user behavior may include online activities of the user including browsing undertaken by the user, search queries entered by the user, advertisements selected by the user, etc.

At 1006, explicit preference data is received from the user. The preference data may indicate certain items that are of interest to the user, certain brands that are of interest to the user, categories of items that are of interest to the user, etc. Furthermore, preference data from the user can include pricing preferences of the user, including but not limited to certain discount levels, a price range, etc.

At 1008, an item advertisement profile for the user is generated based at least in part upon the historical user behavior and the explicit preference data. The methodology 1000 completes at 1010.

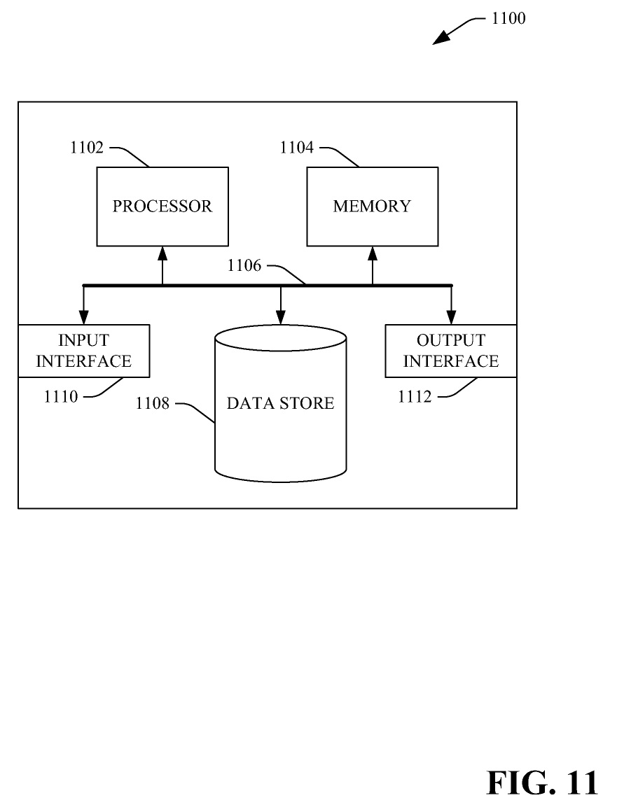

Now referring to FIG. 11, a high-level illustration of an example computing device 1100 that can be used in accordance with the systems and methodologies disclosed herein is illustrated. For instance, the computing device 1100 may be used in a system that supports provision of item advertisements to users. In another example, at least a portion of the computing device 1100 may be used in a system that supports generating item advertisement profiles for users. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store advertisements, item advertisement profiles, etc.

The computing device 1100 additionally includes a data store 1108 that is accessible by the processor 1102 by way of the system bus 1106. The data store 1108 may include executable instructions, item advertisement profiles for users, item advertisements, explicitly provided user preferences, historical data such as search logs, etc. The computing device 1100 also includes an input interface 1110 that allows external devices to communicate with the computing device 1100. For instance, the input interface 1110 may be used to receive instructions from an external computer device, explicit item preferences from the user, etc. The computing device 1100 also includes an output interface 1112 that interfaces the computing device 1100 with one or more external devices. For example, the computing device 1100 may display text, images, etc. by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
accessing a data repository that comprises an item advertisement profile for a user, wherein the item advertisement profile for the user comprises data pertaining to items of interest to the user and pricing preferences that correspond to at least one item of interest to the user;
selecting an item advertisement for a particular item from a plurality of possible item advertisements based at least in part upon the item advertisement profile for the user;
causing the advertisement for the particular item to be displayed to the user on a display screen of a computing device.

2. The method of claim 1, wherein the pricing preferences include a price range for the user.

3. The method of claim 1, wherein the pricing preferences include a percentage off a suggested retail price.

4. The method of claim 1, wherein the item advertisement profile is based at least in part upon advertisement preferences explicitly provided by the user.

5. The method of claim 1, wherein the item advertisement profile is based at least in part upon inferred item preferences of the user.

6. The method of claim 5, wherein the item preferences are inferred based at least in part upon historic search queries issued to a search engine from the user.

7. The method of claim 5, wherein the item preferences are inferred based at least in part upon historic browsing activities of the user.

8. The method of claim 1, further comprising:
receiving a search query from the user; and
selecting the item advertisement for the particular item based at least in part the received search query.

9. The method of claim 1, further comprising:
receiving data indicative of a web page currently viewed by the user; and
selecting the item advertisement for the particular item based at least in part upon the received data that is indicative of the web page currently viewed by the user.

10. The method of claim 1, further comprising:
receiving contextual data pertaining to the user; and
selecting the item advertisement for the particular item based at least in part upon the contextual data pertaining to the user.

11. The method of claim 10, wherein the contextual data comprises at least one of the following: current location of the user, computer device being utilized by the user, time of day, day of a week, time of a year, current or predicted weather conditions, a current news item, or an event occurring proximate to the user.

12. The method of claim 1, further comprising:
receiving explicit instructions from the user pertaining to the pricing preferences of the user; and
failing to select a certain one of the plurality of possible item advertisements due to violation of the received explicit instructions.

13. The method of claim 1, further comprising:
determining an amount of advertisement space on a web page that is to be displayed to the user on the computer display screen; and
causing the item advertisement for the particular item to be displayed on an upper half of the web page.

14. The method of claim 13, further comprising:
receiving a search query from the user;
executing an auction for advertisement space on the web page amongst a plurality of possible advertisers;
selecting at least one other advertisement based at least in part upon the auction; and
causing the at least one other advertisement to be displayed on a lower half of the web page.

15. A system comprising the following computer-executable components:
an accessor component that
a) receives one of a search query from a user or an identity of a web page desirably viewed by the user; and
b) accesses a data repository that comprises an item advertisement profile for the user, wherein the item advertisement profile for the user comprises data pertaining to items of interest to the user and pricing preferences for items of interest to the user;
an advertisement selector component that selects at least one item advertisement from a plurality of possible item advertisements based at least in part upon the search query or the identity of the web page and the item advertisement profile for the user; and
a display component that causes the at least one item advertisement to be displayed to the user on a display screen of a computing device.

16. The system of claim 15, wherein the computing device is a mobile computing device, and wherein the display component causes the at least one advertisement to be displayed on the mobile computing device.

17. The system of claim 15, further comprising a profile updater component that receives the search query or the identity of the web page and updates the item advertisement profile for the user based at least in part upon the received search query or the identity of the web page.

18. The system of claim 15, wherein the item advertisement profile comprises explicit preferences from the user pertaining to a discount level of items.

19. The system of claim 15, further comprising a profile generator component that generates the item advertisement profile for the user based at least in part upon search history of the user, browsing history of the user, and advertisement preferences explicitly provided by the user.

20. A computer-readable medium comprising instructions that, when executed by a processor, perform the following acts:
receive a search query issued by a user of a search engine;
access a data repository that comprises an item advertisement user profile, wherein the item advertisement user profile comprises data that is indicative of item preferences of the user and price discount preferences of the user with respect to one or more items of interest to the user;
select at least one item advertisement from a plurality of item advertisements based at least in part upon the search query issued by the user and the item advertisement profile;
cause search results pertaining to the search query to be displayed to the user; and
cause the at least one item advertisement selected from the plurality of possible advertisements to be displayed to the user together with the search results.
